(19) United States
(12) Patent Application Publication
(10) Pub. No.: US 2010/0236676 A1
(43) Pub. Date: Sep. 23, 2010

(54) Graphics for personalization or customization of tire sidewalls

(75) Inventor: Mars Lans, Highland Park, IL (US)

Correspondence Address: JOHN S. HALE;GIPPLE & HALE, 6665-A OLD DOMINION DRIVE, MCLEAN, VA, 22101, US

(73) Assignee: Ego Wheelz Corp.

(21) Appl. No.: 12/381,845

(22) Filed: Mar. 18, 2009

(51) Int. Cl. B60C 13/00; B29D 30/00

(52) U.S. Cl. 152/151; 156/123

(57) ABSTRACT

A system and method for the application of custom or personalized graphics to a tire sidewall. A flexible frame having graphics mounted thereto is temporarily attached adjacent the wheel rim of a mounted tire, thereby guiding the positioning of the graphics. The graphics are then permanently attached to the tire sidewall and the flexible frame is severed from the graphics.

### RELATED APPLICATIONS

There are no related applications.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### FIELD OF THE INVENTION

The present invention generally relates to custom graphics for tire sidewalls and the like. More specifically, this invention relates to custom designs, messages or statements, and alphanumeric text that can be affixed to the sidewall of a vehicle tire using a method and apparatus that ensures they are applied symmetrically and in an otherwise aesthetically pleasing manner.

### BACKGROUND OF THE INVENTION

It has often been said that we are a culture that loves its cars. Songs have been written about them. Books extol their virtues, and more recently, they have even become the subjects of entire movies. Men, in particular, have been known to spend more than the value of the car itself to customize their vehicle, either to make it more uniquely theirs, increase its performance, or some combination therebetween. Popular television shows like the MTV network's “Pimp My Ride” document the transformation of everyday vehicles into showpieces and the yearly Specialty Equipment Market Association (SEMA) convention in Las Vegas, Nevada showcases the latest available technology for what has grown into a multi-billion dollar industry. Nearly everything imaginable (and often unimaginable) can be purchased in this so-called aftermarket and can usually be installed by a reasonably skilled owner. For example, items to dress up the vehicles running gear are well known. Custom wheels (i.e., rims) are available in multitudes of designs that facilitate the installation of high performance tires or make the vehicle more attractive, and devices that spin on the wheel hubs have recently become fashionable to simulate motion of the vehicle even when at a standstill. Nothing, however, has heretofore been available to customize the tire itself.

Labeling has likely been a part of tire manufacture since their inception. Automobile, motorcycle, truck, and even bicycle tires usually carry information on their sidewalls that indicate the name of the manufacturer, the size of the tire, and multitudes of additional information, for example the date of manufacture, their intended use, and an indication of their expected longevity, traction, and load-carrying capacities. Generally, this information is molded or stamped into the tire sidewall during manufacture and in many cases this lettering is overpainted in a contrasting color (usually white) to both make the text easier to read and to increase the aesthetic appeal of the tire.

To date, however, nothing is available to customize the appearance of tire sidewalls. Stickers used to display, for example, a user's sentiment or opinion, market a product, or advertise a destination are well known, particularly with regard to vehicles. Bumper stickers have become a common form of expression and children all over the Western world collect stickers. While any of these items may ostensibly be applied to a tire sidewall, the results are generally unsatisfactory. The extreme heat and flexing that tires are subject to while in use inevitably result in any such sticker falling off soon after its application. More importantly, application of the graphics, particularly long statements or phrases rendered in large type, is difficult to perform in an aesthetically pleasing manner because of the curvature of the tire itself. For example, everyone has witnessed examples of commonly available individual self-adhesive alphanumeric characters inexpertly applied to a store window or the rear glass of a vehicle. The characters are crooked or the spacing between the letters is uneven. Many of these instances are preventable with the simple use of a straightedge and a ruler to ensure constant spacing between the characters. However, no such assistance is available for surfaces having a curvature such as the sidewall of a vehicle tire. And whereas characters applied in a straight line will have constant spacing between each character, characters following the curvature of a tire sidewall must necessarily have progressively greater space between the uppermost regions of the characters compared to the spacing in the lower regions in order to follow the curve. In these instances, the user must simply “eyeball” his efforts and hope that the results are acceptable.

### SUMMARY OF THE INVENTION

The present invention is a system for the application of graphics for the personalization or customization of tire sidewalls, and accommodates any diameter tire. Adhesable graphics, phrases, statements, individual alphanumeric characters, and the like are rendered in a flexible material appropriate for attachment to a tire sidewall and are removably affixed to a flexible frame. In use, the frame is temporarily attached adjacent the wheel rim and is used to facilitate affixing the graphics or figures to the sidewall in an aesthetically pleasing manner. The frame ensures that any lettering or characters are appropriately spaced regardless of the diameter of the tire to which the graphics will be attached.

The flexible frame can be manufactured from any rod-like flexible material so long as it can be bent as desired by the hand pressure of the user and tends to hold its shape. In a preferred embodiment, the frame is essentially a plastic or rubber rod with a solid wire core. The frame includes a low-tack adhesive applied to its exterior surface that is used to temporarily attach the frame adjacent the tire sidewalls. Methods for temporarily attaching the frame are well known and, in addition, may include a clip arrangement for temporary attachment to the rim of the vehicle.

The graphics may be any arbitrary or fanciful design, or may consist of words, phrases, or inspirational statements. The graphics may also consist of a plurality of alphanumeric characters that may be removably attached to the frame in a sequence selected by the user. In this manner, the user is able to create his or her own customized statements for display on the tire. The graphics can be manufactured from any flexible material, including but not limited to rubber, synthetic rubber, latex, vinyl, polyethylene, biaxially-oriented polyethylene terephthalate film, organic and inorganic polymers, aluminum, metallic alloys, and metallic foils; and are from about 0.5 mm to 3.0 mm, preferably about 2.0 mm in thickness. The graphics may be attached to the tire sidewall via a self-adhesive whereby the user simply peels backing paper away from the graphics to reveal a pre-applied adhesive, or the user may simply use adhesive provided with the kit or secured from a third party to permanently attach the graphics. In a preferred embodiment, the graphics are attached to the sidewall via a cold vulcanization process.

The graphics are removably attached to the frame in any conventional manner whereby the graphics, figures, characters, etc. are generally orthogonal to the frame. In a preferred embodiment, the graphics are attached via a plurality of sprues that are simply severed once the graphics are permanently attached to the tire sidewall, thereby allowing the frame to be removed and discarded. With regard to graphics consisting of user selectable alphanumeric characters, other means of removable attachment are necessary. Such means are well known and may include adhesives; interlocking male/female, post and socket type arrangements; hook and loop means; or other well known mechanisms for removably attaching the graphics in any arbitrary sequence selected by the user. While positioned generally orthogonally when removably attached to the frame prior to use, it is noted that one feature of this invention is that the graphics will tend to change their conformation relative to one another as the frame is flexed. In other words, as the frame is flexed to accommodate the curvature of the tire sidewall, the position of the graphical elements will change relative to one another such that the spacing in the vicinity of the top (or bottom, depending on whether the frame is attached to the bottom or top portion of the graphics) of each graphical element will narrow (or expand) to conform to the curvature of the tire sidewall. The graphics can thereby be applied to essentially any tire, regardless of diameter and the graphics will be aesthetically positioned evenly about the circumference of the tire such that an imaginary midline drawn through the center of each character will intersect at the same center (i.e., the wheel hub).

It is contemplated that the frame may be removably attached below the graphics whereby the device is utilized by temporarily attaching the frame adjacent the outermost diameter of the wheel when using the device. Additionally, the frame may be removably attached above the graphics whereby instead of guiding application of the graphics using the vehicle's wheel, the frame is instead temporarily attached adjacent the tire tread of the vehicle. In yet another version, the frame may be removably attached to the right or left side of graphics consisting of alphanumeric characters where it is desired that the text be legible in an essentially vertical orientation.

It is an object of the invention to provide graphics, including fanciful designs, words, phrases, inspirational statements, and alphanumeric characters, for application to a tire sidewall;

It is another object of this invention to provide a graphics application system including a frame to facilitate application of graphics to a tire sidewall in an aesthetically pleasing manner;

It is yet another object of this invention to facilitate the application of alphanumeric characters to a tire sidewall in a user selectable sequence; and,

It is still another object of this invention to provide user customizable graphics for attachment to a tire sidewall.

### BRIEF DESCRIPTION OF THE DRAWINGS

FIG. 1 is a plan view of the invention applied to a vehicle tire;

FIG. 2 is a perspective view of the invention with frame attached;

FIG. 3 is a detail view of a single alphanumeric character attached to the frame;

FIG. 4 is a perspective view of the invention with frame flexed to accommodate a tire rim;

FIG. 5 is a perspective view of the invention with sprues severed and the frame ready for removal;

FIG. 6 is a plan view of the frame of an alternate embodiment;

FIG. 7 is a plan view of the flexed frame of an alternate embodiment ready to be temporarily attached adjacent the tire rim; and,

FIG. 8 is a perspective view of the frame of the alternate embodiment temporarily attached to the wheel rim to guide the application of alphanumeric characters in a user selected sequence.

### DETAILED DESCRIPTION OF THE INVENTION

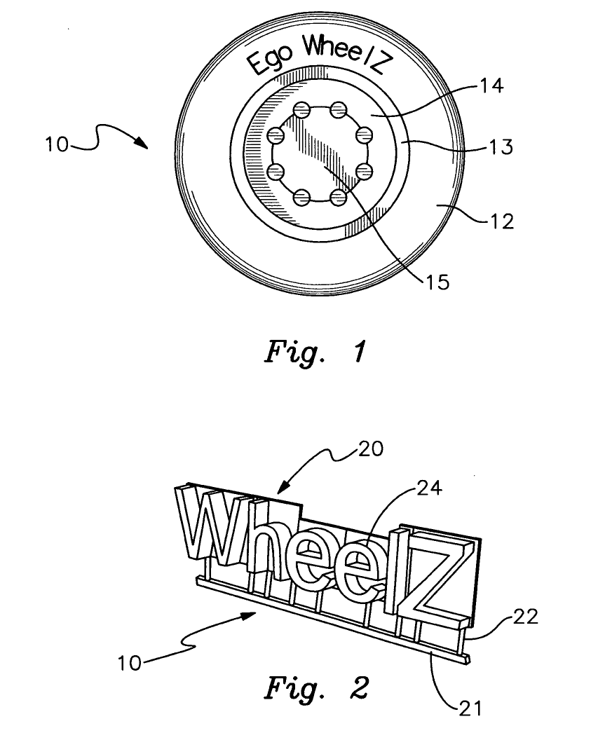

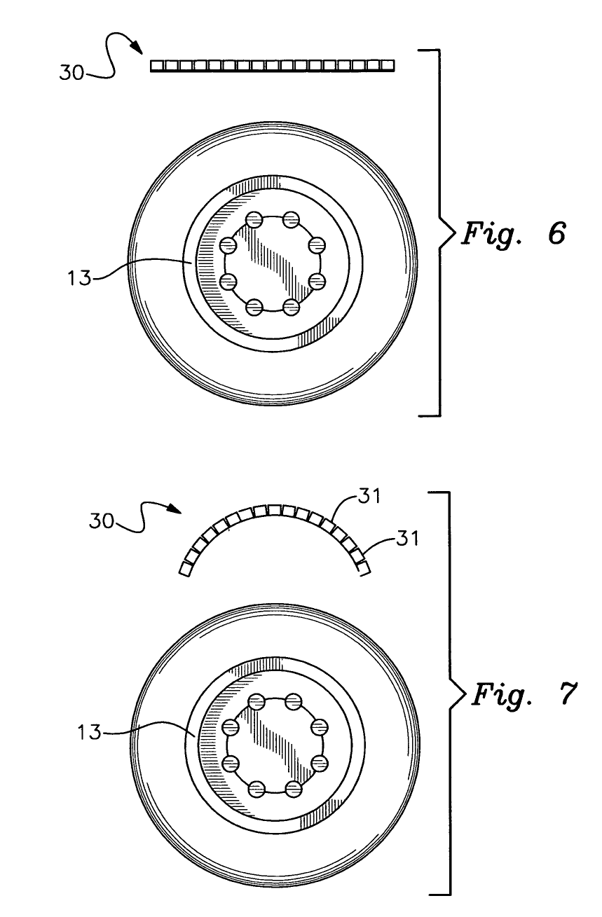

The preferred embodiments and best modes of the invention are shown in FIGS. 1 through 8. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

FIGS. 1 through 5 show the graphical system 10 of a preferred embodiment. The system 10 may be attached to the tire via any conventional means. Attachment means for the graphics 20 includes self stick adhesives, an adhesive provided in the packaging, and preferably, a cold vulcanization process. The frame 21 may be attached using a low tack, low residue adhesive applied to its back. It is also contemplated that clips may be used to temporarily attach the frame 21 to the wheel rim. FIG. 1 shows an exemplary alphanumeric graphic applied to a tire sidewall 12. The frame (not shown) and attachment sprues (not shown) have been removed and the invention is ready for use.

Turning now to FIG. 2, the graphical system 10 is shown prior to application to a tire sidewall. The graphics 20 are manufactured from any flexible material, including but not limited to rubber, synthetic rubber, latex, vinyl, polyethylene, biaxially-oriented polyethylene terephthalate film, organic and inorganic polymers, aluminum, metallic alloys, and metallic foils; and are from about 0.5 mm to 3.0 mm, preferably about 2.0 mm in thickness. They may optionally be reflective or be provided in multiple colors. The graphics 20 include a self-adhesive backing whereby the user simply peels backing paper away to reveal a pre-applied adhesive, or the user may simply use adhesive provided with the kit or secured from a third party to permanently attach the graphics. Preferably, the graphics 20 are attached to the sidewall via a cold vulcanization process. A word with fanciful spelling is depicted in FIG. 2. However, this invention contemplates any graphical representation that can be depicted on a vehicle tire. A plurality of easily severable sprues 22 interconnect each graphical element 24 of the graphics 20 to the frame 21 of the graphical system 10. In general, a single sprue 22 is used to connect each element 24 to the frame, although larger elements 24 can require two or more sprues 22 in order to be securely connected to the frame 21. The frame 21 can be manufactured from any flexible material that tends to hold its shape when bent. In the preferred embodiment, the frame 21 consists of a plastic or rubber coated wire core, although other appropriate materials will be obvious to one skilled in this art.

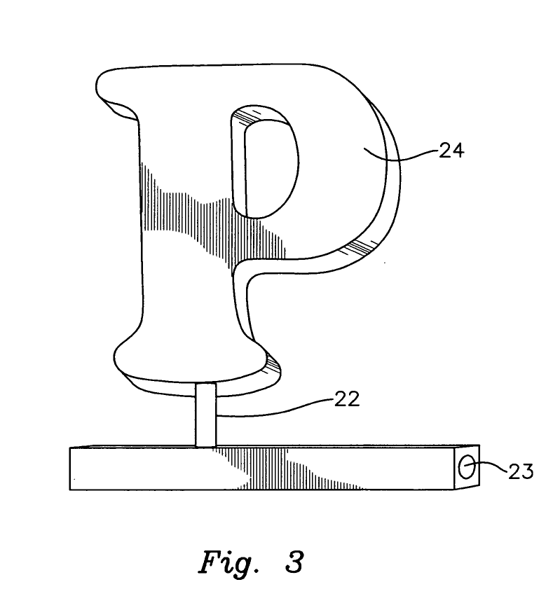

FIG. 3 shows is a detailed view of the system components and shows one graphical element 24 interconnected via its sprue 22 to the frame 21. Also visible is the malleable wire core 23 of the frame 21. Once the frame 21 is bent into its desired position, the wire core 23 maintains this conformation to facilitate positioning and attachment of the graphics 20.

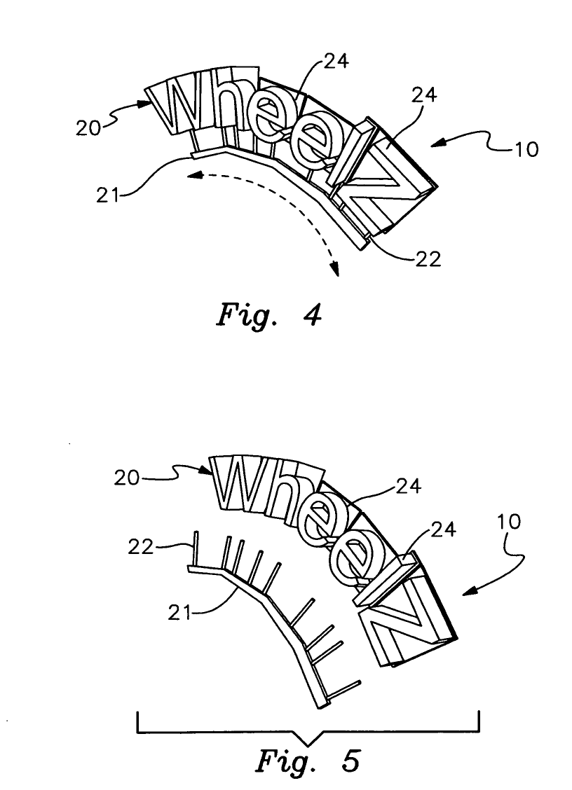

FIGS. 4 and 5 show the inventive system 10 immediately prior to the temporary attachment of its frame 21 adjacent the wheel rim 13 of a mounted tire (FIG. 4) and after the graphics 20 are attached to the tire sidewall (FIG. 5). In the interest of clarity, the tire sidewall is not shown. In use, the frame 21 is simply bent to accommodate the curvature of the tire, then affixed either to the rim itself or adjacent thereto such that the frame 21 traces a constant radius relative to the wheel hub (part 15, FIG. 1). In a preferred embodiment, a low-tack, low residue adhesive is provided for attachment, but this invention contemplates any commonly available method of attachment, including but not limited to clips. Bending of the frame 21 to accommodate the tire's curvature necessarily bends the graphics 20 accordingly, with each element 24 maintaining a proportionate distance relative to its nearest neighbor whereby convexly bending the frame 21 causes the spacing between the uppermost portions of each element 24 to increase proportionately. The result is an aesthetically pleasing distribution of the graphics 20 at a predetermined constant radius around at least a portion of the tire sidewall. With each graphical element 24 now in position, the graphics can be permanently attached to the tire sidewall using previously known attachment methods, including via various adhesives or preferably, a cold vulcanization process. Thereafter, the sprues 22 are severed and the frame 21 is discarded, leaving only the graphics 20 permanently attached to the tire sidewall 12.

FIGS. 6 through 8 depict an alternate embodiment 30 whereby the graphics consist of alphanumeric characters (not shown) and are attached to the tire sidewall in any arbitrary sequence selected by the user. The frame 31 is attached as previously described above. However, this embodiment allows each graphical element 24 to be mounted to the frame in a sequence determined by the user. Methods for removably attaching each graphical element 24 are well known and include, but are not limited to adhesives, a male/female type post and socket mechanism, or hook and loop means. In this manner, the user, can for example, spell out his or her name, or any other sentiment that would not otherwise be available for purchase. The graphics 20 are then installed as described above, including temporarily attaching the frame 31 adjacent the wheel rim 13, cold vulcanizing each graphical element 24 to the tire sidewall 12, severing the graphical elements 24 from the frame 31, then removing and discarding the frame 31.

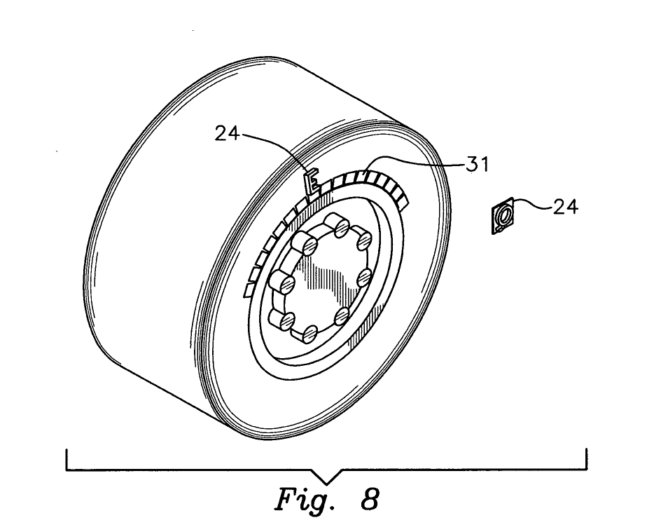

FIG. 8 is a stylized depiction of the positioning of the graphical elements 24 on the frame 31.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1) A system for graphical personalization and customization of tire sidewalls comprising:
a rod-like frame having temporary attachment means;
flexible graphics removably attached to said frame; and,
affixation means for permanently affixing said graphics to said sidewalls.

2) A system for graphical personalization and customization of tire sidewalls as claimed in claim 1 wherein said frame temporary attachment means is a low tack adhesive.

3) A system for graphical personalization and customization of tire sidewalls as claimed in claim 1 wherein said frame temporary attachment means are clips attachable to a wheel rim.

4) A system for graphical personalization and customization of tire sidewalls as claimed in claim 1 wherein said graphics are manufactured from a manufactured from a material selected from the group consisting of rubber, synthetic rubber, latex, vinyl, polyethylene, biaxially-oriented polyethylene terephthalate film, organic and inorganic polymers, aluminum, metallic alloys, and metallic foils.

5) A system for graphical personalization and customization of tire sidewalls as claimed in claim 4 wherein said graphics are about 0.5 mm to about 4.0 mm in thickness, preferably about 2.0 mm in thickness.

6) A system for graphical personalization and customization of tire sidewalls as claimed in claim 1 wherein said graphics are evenly spaced along said frame, a plurality of severable sprues removably connecting said graphics to said frame.

7) A system for graphical personalization and customization of tire sidewalls as claimed in claim 1 wherein said graphics are removably attached above or below said frame.

8) A system for graphical personalization and customization of tire sidewalls as claimed in claim 1 wherein said graphics are selected from the group consisting of alphanumeric characters, inspirational or informative statements, readable text, phrases, and fanciful designs.

9) A system for graphical personalization and customization of tire sidewalls as claimed in claim 8 wherein said alphanumeric characters are removably attached to said frame in a user selectable sequence.

10) A system for graphical personalization and customization of tire sidewalls as claimed in claim 1 wherein said graphics are reflective.

11) A system for graphical personalization and customization of tire sidewalls as claimed in claim 1 wherein said graphics are a contrasting color.

12) A system for graphical personalization and customization of tire sidewalls as claimed in claim 1 wherein said graphics are permanently affixed by cold vulcanization.

13) A system for graphical personalization and customization of tire sidewalls comprising:
a low tack adhesive-backed, temporarily attachable rod-like frame; and,
permanently self adhesive flexible graphics interconnected to said frame by sprues, said graphics being attached in substantially the same plane.

14) A system for graphical personalization and customization of tire sidewalls as claimed in claim 13 wherein said graphics are manufactured from a manufactured from a material selected from the group consisting of rubber, synthetic rubber, latex, vinyl, polyethylene, biaxially-oriented polyethylene terephthalate film, organic and inorganic polymers, aluminum, metallic alloys, and metallic foils.

15) A system for graphical personalization and customization of tire sidewalls as claimed in claim 14 wherein said graphics are about 0.5 mm to about 4.0 mm in thickness, preferably about 2.0 mm in thickness.

16) A system for graphical personalization and customization of tire sidewalls as claimed in claim 13 wherein said graphics are evenly spaced along said frame, a plurality of severable sprues removably connecting said graphics to said frame.

17) A system for graphical personalization and customization of tire sidewalls as claimed in claim 13 wherein said graphics are removably attached above or below said frame.

18) A system for graphical personalization and customization of tire sidewalls as claimed in claim 13 wherein said graphics are selected from the group consisting of alphanumeric characters, inspirational or informative statements, readable text, phrases, and fanciful designs.

19) A system for graphical personalization and customization of tire sidewalls as claimed in claim 18 wherein said alphanumeric characters are removably attached to said frame in a user selectable sequence.

20) A system for graphical personalization and customization of tire sidewalls as claimed in claim 13 wherein said graphics are reflective.

21) A system for graphical personalization and customization of tire sidewalls as claimed in claim 13 wherein said graphics are a contrasting color.

22) A system for graphical personalization and customization of tire sidewalls as claimed in claim 13 wherein said graphics are permanently affixed by cold vulcanization.

23) A method for graphical personalization and customization of tire sidewalls comprising:
temporarily attaching a flexible frame adjacent a tire sidewall and at a constant radius, said frame having a plurality of permanently self-adhesive graphics removably attached thereto;
said frame thereby positioning said graphics at a constant radius adjacent said tire sidewall;
cold vulcanizing said graphics to said tire sidewall; and,
removing and cutting said frame away from said graphics.
